(19) United States
(12) Patent Application Publication
(10) Pub. No.: US 2025/0107677 A1
(43) Pub. Date: Apr. 3, 2025

(54) CLASSIFICATION DEVICE AND DUST COMPACTION SYSTEM

(71) Applicant: SINTOKOGIO, LTD., Nagoya-shi (JP)

(72) Inventors: Noriaki MASAKI, Nagoya-shi (JP); Koh Saito, Nagoya-shi (JP); Shintaro Nishikawa, Nagoya-shi (JP); Atsushi Hata, Nagoya-shi (JP)

(73) Assignee: SINTOKOGIO, LTD., Nagoya-shi (JP)

(21) Appl. No.: 18/886,201

(22) Filed: Sep. 16, 2024

(30) Foreign Application Priority Data
Oct. 2, 2023 (JP) 2023-171312

(51) Int. Cl. A47L 9/10; A47L 7/00; A47L 9/12; A47L 9/14; B08B 15/04

(52) U.S. Cl. CPC A47L 9/108; A47L 7/0047; A47L 9/122; A47L 9/1445; B08B 15/04

(57) ABSTRACT

A classification device includes a hose configured to suck dust containing fine dust and foreign matter, a body defining a classification space therein, connected to the hose, including an upper discharge port and a lower discharge port, the upper discharge port being provided in an upper portion of the body so as to be connected to a suction device, and the lower discharge port being provided in a lower portion of the body, a lid member configured to be mounted on a container defining a storage space for storing the foreign matter discharged from the lower discharge port of the body, including an air intake configured to communicate with the storage space, and positioned below the body, and an air introduction pipe connected to the air intake of the lid member and configured to be disposed in the storage space.

### CROSS-REFERENCE TO RELATED APPLICATION

This application is based on Japanese Patent Application No. 2023-171312 filed with Japan Patent Office on Oct. 2, 2023, the entire contents of which are hereby incorporated by reference.

### TECHNICAL FIELD

The present disclosure relates to a classification device and a dust compaction system.

### BACKGROUND

Japanese Patent Application Laid-Open No. H04-123898 discloses a device for compress waste. The device includes a hopper for storing the waste, a compression chamber provided below the hopper, and compression means for compressing the waste from above and the sides of the compression chamber to compress the waste.

### SUMMARY

In the device described in Japanese Patent Application Laid-Open No. H04-123898, when the waste is dust, an operation abnormality may occur due to foreign matter mixed in the dust. The present disclosure provides a technique for appropriately separating foreign matter from dust.

According to an aspect of the present disclosure, there is provided a classification device including a hose configured to suck dust containing fine dust and foreign matter from a tip thereof, a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space, a lid member configured to be mounted on a container defining a storage space for storing the foreign matter discharged from the lower discharge port of the body, including an air intake configured to communicate with the storage space, and positioned below the body, and an air introduction pipe connected to the air intake of the lid member and configured to be disposed in the storage space.

According to another aspect of the present disclosure, there is provided a dust compaction system including a classification device and a compaction device, wherein the classification device includes a hose configured to suck dust containing fine dust and foreign matter from a tip thereof, a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space, a lid member configured to be mounted on a container defining a storage space for storing the foreign matter discharged from the lower discharge port of the body, including an air intake configured to communicate with the storage space, and positioned below the body, and an air introduction pipe connected to the air intake of the lid member and configured to be disposed in the storage space, and, wherein the compaction device is configured to receive the fine dust having passed through the upper discharge port of the body and compresses the fine dust to form a pellet.

According to the present disclosure, foreign matter can be appropriately separated from dust.

### BRIEF DESCRIPTION OF DRAWINGS

FIG. 1 is a diagram illustrating an overview of a dust compaction system according to an embodiment.

FIG. 2 is a side view illustrating an example of a classification device and an example of a suction device connected to the classification device according to an embodiment.

FIG. 3 is a diagram illustrating an example of the coarse filter in FIG. 2.

FIG. 4 is a perspective view showing an example of the classification device in FIG. 2.

FIG. 5 is a cross-sectional view showing an example of the classification device in FIG. 2.

FIG. 6 is a partial cross-sectional view showing an example of the classification device in FIG. 2.

FIG. 7 is a perspective view showing an example of an inspection lid and a filter.

### DETAILED DESCRIPTION

Embodiments of the present disclosure will be described in detail with reference to the drawings. In the description of the drawings, the same element is denoted by the same symbol, and redundant description is omitted. The dimensional ratios in the drawings do not necessarily coincide with those in the description. The terms “upper”, “lower”, “left”, and “right” are based on the state shown in the drawings and are used for convenience.

### Example of Dust Compaction System

A dust compaction system according to an embodiment is a system for compacting dust collected in, for example, a factory. The dust is a fine powder that can be suspended in a gas, and includes a fume or the like. The fume is generated during laser processing, plasma processing, or welding of metal materials or the like. The compaction is to compress the powder.

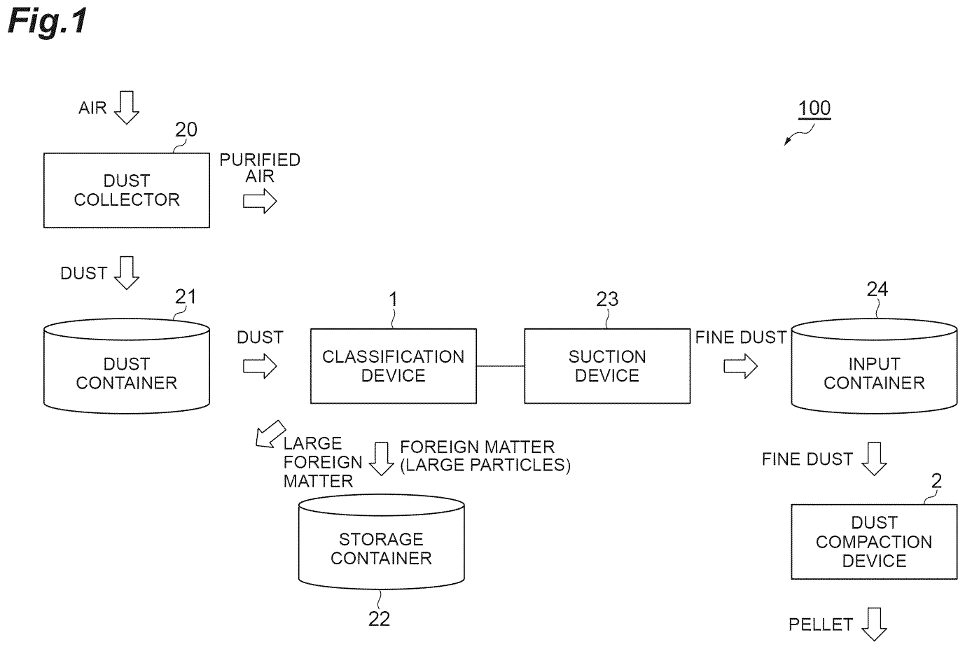

FIG. 1 is a diagram illustrating an overview of a dust compaction system according to an embodiment. In a factory or the like, a dust collector 20 is installed. The dust collector 20 takes in air to remove the dust and releases purified air. The dust collector 20 stores the dust removed from the air in a dust container 21. The dust container 21 may be a box attached to the dust collector 20, or a pail. A dust compaction system 100 shown in FIG. 1 compacts the dust contained in the dust container 21 to form a pellet. In the present embodiment, an object obtained by compacting the powder is referred to as the pellet.

As shown in FIG. 1, the dust compaction system 100 includes a classification device 1 and a compaction device 2. The classification device 1 is connected to a suction device 23 and sucks the dust stored in the dust container 21. The classification device 1 classifies the sucked dust into foreign matter (large particles) and fine dust. The large particles are dust having a particle diameter of several tens of μm to several mm, and includes a sputter. The fine dust is dust having a particle diameter of 0.1 μm to several μm, and includes the fume. The classification device 1 may not suck large foreign matter into the classification device 1 when sucking the dust. The large particles classified by the classification device 1 are accommodated in a storage container 22 (an example of a container). The storage container 22 is a pail as an example. The fine dust classified by the classification device 1 is stored in an input container 24 through the suction device 23. The input container 24 is a pail as an example. The fine dust contained in the input container 24 is put into the compaction device 2. For example, when charging the fine dust, an attachment connected to a charging port of the compaction device 2 is attached to the input container 24. The compaction device 2 and the input container 24 are connected via the attachment, and the fine dust is charged into the compaction device 2. The compaction device 2 is a device that compacts the dust to form the pellet. The compaction device 2 compresses the fine dust to form the pellet. Since the pellet is less likely to scatter than the dust, the exposure of the worker to the dust can be reduced, and since the pellet has a smaller volume compared to when in powder form, the waste disposal cost can be reduced.

### Overview of Classification Device

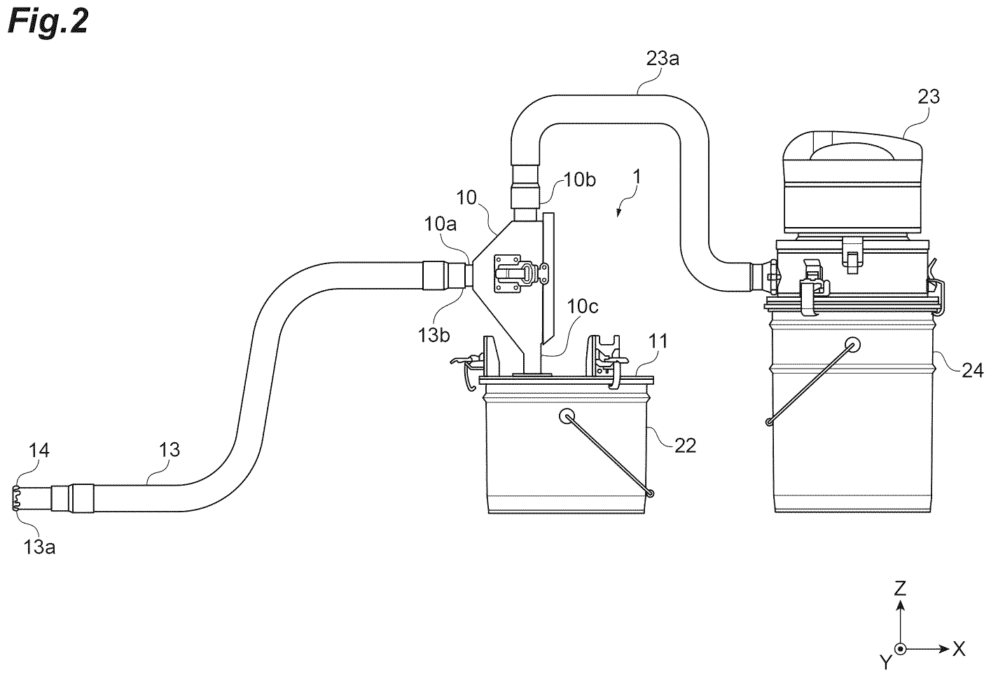

FIG. 2 is a side view illustrating an example of a classification device and an example of a suction device connected to the classification device according to an embodiment. As shown in FIG. 2, the classification device 1 includes a body 10 defining a classification space therein, and a lid member 11 located below the body 10. The body 10 has, for example, a substantially rectangular parallelepiped shape, and the lid member 11 has, for example, a substantially disc shape. The lower portion 10c of the body 10 is supported by the lid member 11. Thus, the body 10 is erected on the upper surface of the lid member 11. The lid member 11 is mounted on the storage container 22 containing the large particles. The storage container 22 is a generally cylindrical pail with an open upper end. As will be described later, the lower end of the body 10 is formed with a lower discharge port and passes through the lid member 11. Thus, the classification space defined inside the body 10 communicates with the inside of the storage container 22.

A side portion of the body 10 is provided with a suction port 10a for taking the dust into the body 10. An end 13b of a first hose 13 (an example of hose) is connected to the suction port 10a. As a result, the inside of the body 10 communicates with the first hose 13. The first hose 13 may be a flexible pipe made of plastic or the like or a rigid pipe made of metals or the like. The first hose 13 sucks the dust from a tip 13a. The dust includes fine dust and large particles.

The upper portion of the body 10 is provided with an upper discharge port 10b for connecting with the suction device 23 for making the classification space a negative pressure. The suction device 23 and a second hose 23a are connected to the upper discharge port 10b. As a result, the inside of the body 10 communicates with the second hose 23a. The suction device 23 is a device that generates a suction force and includes, for example, a fan and a motor. The suction device 23 is detachably attached to the input container 24 and stores the sucked fine dust in the input container 24.

When the suction device 23 starts sucking, the dust is sucked from the tip 13a of the first hose 13. The dust reaches the classification space defined inside the body 10 from the suction port 10a. The large particles contained in the dust pass through the lower portion 10c of the body 10 and the lid member 11, and are stored in the storage container 22. The fine dust contained in the dust passes through the upper discharge port 10b and the second hose 23a and is stored in the input container 24. As described above, the large particles contained in the dust are stored in the storage container 22, and the fine dust contained in the dust is stored in the input container 24.

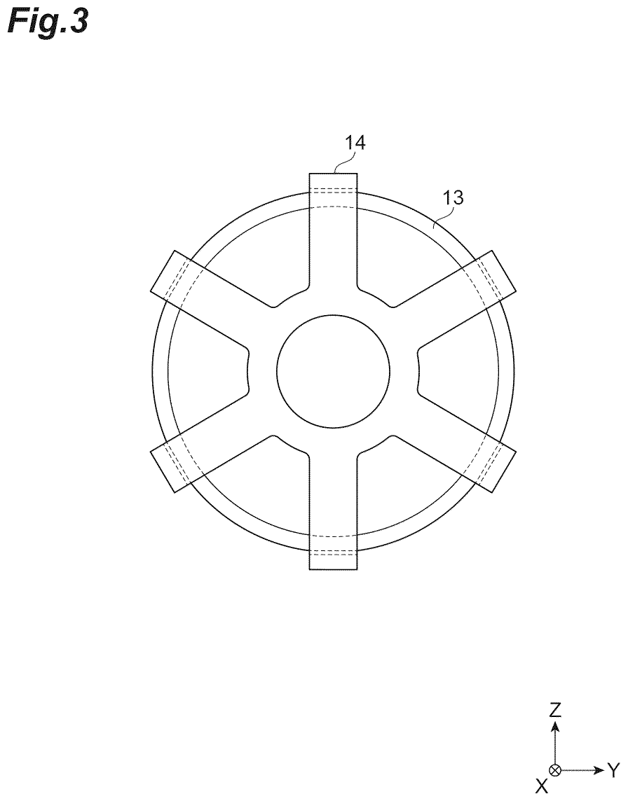

The tip 13a in the first hose 13 may be provided with a coarse filter 14 to exclude large foreign matter. FIG. 3 is a diagram illustrating an example of the coarse filter of FIG. 2. As shown in FIG. 3, the coarse filter 14 has a plurality of openings. Each of the plurality of openings is smaller than the opening of the first hose 13. Thus, the coarse filter 14 can prevent the large foreign matter from being sucked into the classification device 1.

### Details of Classification Device

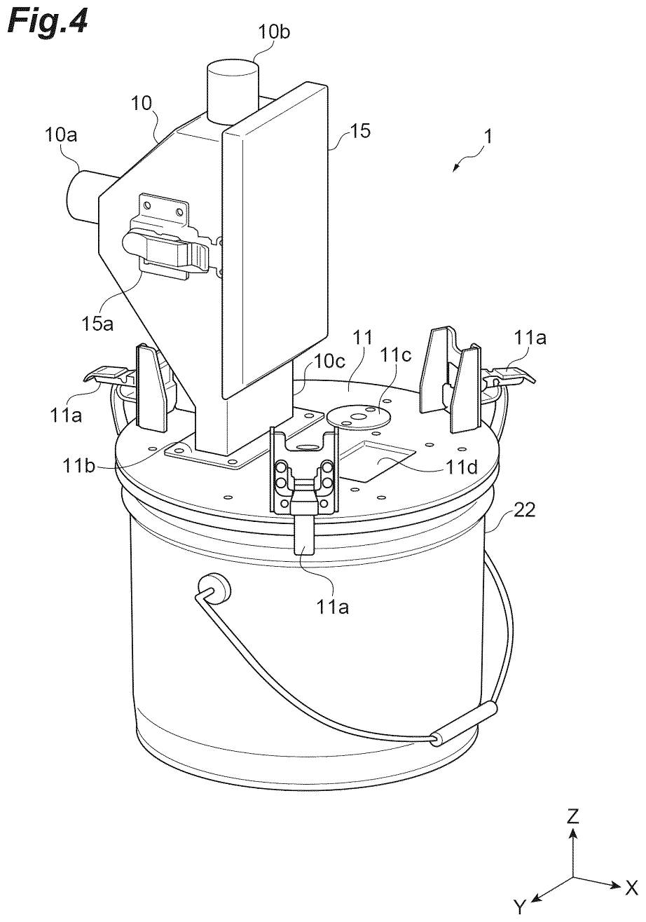

FIG. 4 is a perspective view showing an example of the classification device of FIG. 2. As shown in FIG. 4, the body 10 of the classification device 1 is attached to the storage container 22 together with the lid member 11. For example, the lid member 11 is removably attached to the storage container 22 by three circumferentially equally spaced locking mechanisms 11a. The connector between the lid member 11 and the storage container 22 is made airtight. The locking mechanism 11a is for example a catch clip.

An opening 11b with which the lower portion 10c of the body 10 communicates is formed in the lid member 11. Thus, the classification space of the body 10 communicates with the inside of the storage container 22. An air intake 11c communicating with the inside of the storage container 22 is formed in the lid member 11. The lid member 11 may be provided with a window 11d through which the inside can be visually recognized. The body 10 may be configured to be openable by an inspection lid 15. The inspection lid 15 constitutes a part of the side wall facing the suction port 10a. The inspection lid 15 is removably attached to the body 10 by an attachment metal fitting 15a.

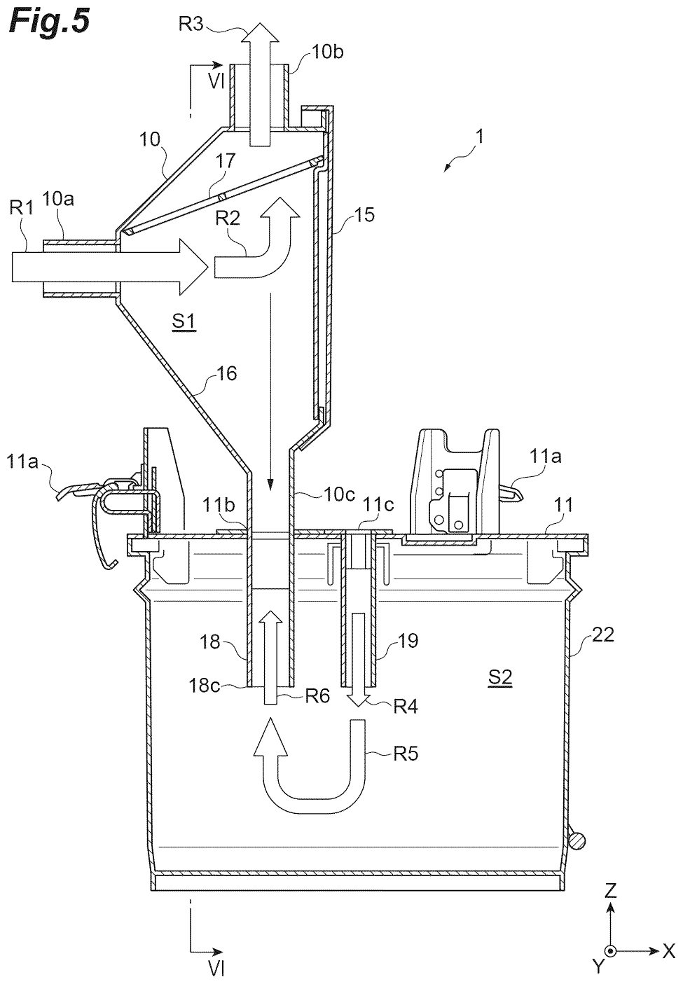

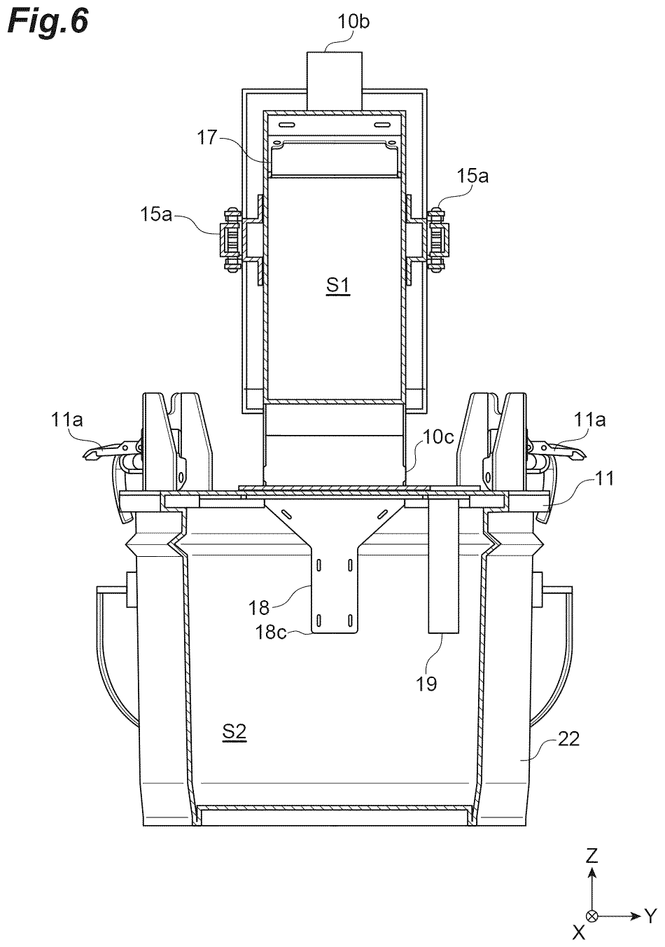

FIG. 5 is a cross-sectional view showing an example of the classification device of FIG. 2. FIG. 6 is a partial cross-sectional view showing an example of the classification device of FIG. 2, and shows a cross section taken along line VI-VI of FIG. 5. As shown in FIGS. 5 and 6, a classification space S1 is defined inside the body 10. The classification space S1 may be provided with a filter 17 separating the fine dust and the large particles. The filter 17 is disposed in front of the upper discharge port 10b. The large particles that move toward the upper portion of the body 10 on the airflow without falling are removed by the filter 17.

The lower portion 10c of the body 10 is made of a tube body 18. The tube body 18 is, for example, a tubular body having a rectangular cross section. The tube body 18 may be a straight pipe. The tube body 18 has a smaller cross-sectional area than the cross-sectional area of the center of the body 10 (e.g., the cross-sectional area through the suction port 10a). A lower discharge port 18c is formed at the lower end of the tube body 18. As a result, large particles that have fallen through the classification space S1 are discharged from the lower discharge port 18c and stored in a storage space S2 defined inside the storage container 22.

A air introduction pipe 19 is connected to the air intake 11c formed in the lid member 11. The air introduction pipe 19 is, for example, a cylinder. The air introduction pipe 19 is placed on the storage space S2. The air introduction pipe 19 may be connected to the air intake 11c of the lid member 11 such that the lower end faces the bottom of the storage container 22.

The action of the suction device 23 creates a negative pressure on the classification space S1. As a result, an airflow R1 directed from the tip 13a in the first hose 13 to the classification space S1 of the body 10 is generated. The airflow R1 becomes an airflow R2 that collides with the inspection lid 15 and rises, and becomes an airflow R3 that is discharged from the upper discharge port 10b. The dust sucked by the airflow R1 collides with the inspection lid 15. The fine dust contained in the dust is transported to the upper discharge port 10b of the body 10 on the airflow R2. The large particles contained in the dust fall into the lower portion 10c of the body 10 by gravity, pass through the tube body 18, and are discharged from the lower discharge port 18c. The fine dust may adhere to the large particles. Therefore, the fine dust may fall together with the large particles and reach the storage space S2.

Since the storage space S2 communicates with the classification space S1, it has a negative pressure. Thus, air is taken in from the air intake 11c in the lid member 11. Air is introduced into the storage space S2 through the air introduction pipe 19 as an airflow R4. The air introduced from the air introduction pipe 19 reaches the bottom of the storage container 22 as indicated by an airflow R5 and hits the accumulated large particles. The fine dust attached to the large particles is scattered into the storage space S2 by the airflow R5. Then, an airflow toward the lower discharge port 18c of the body 10 like the airflow R5 is generated. The fine dust scattered in the storage space S2 is carried on an ascending airflow R6 from the lower discharge port 18c of the body 10 to the classification space S1, and further carried on the airflow to the upper discharge port 10b of the body 10.

In this way, the classification device 1 can further remove the fine dust from the large particles which is classified from the dust and stored. Therefore, the classification device 1 can appropriately separate foreign matter from the dust. To suppress the scattering of fine dust even when large particles are discarded from the storage container 22.

In addition, since the lower portion 10c of the body 10 is made of the tube body 18, the ascending airflow R6 heading from the storage space S2 to the classification space S1 is appropriately maintained inside the tube body 18. When the flow rate of the ascending airflow R6 is too high, the large particles falling from the classification space S1 by gravity may be pushed back. When the flow rate in the ascending airflow R6 is too low, not only the fine dust cannot be transported from the storage space S2 to the classification space S1, but also the fine dust may be introduced into the storage space S2.

By adjusting the radius of the air introduction pipe 19, i.e. the cross-sectional area of the air intake 11c, the air intake can be varied. Thus, the flow rate of the ascending airflow R6 can be adjusted. For example, the lower limit of the flow velocity of the ascending airflow R6 in the tube body 18 can be set to the terminal settling velocity at which the dust of about several μm close to the particle diameter of the fume can be transported upward. In this case, the introduction of fine dust into the storage space S2 can be suppressed. For example, the lower limit of the flow rate of the ascending airflow R6 can be set to 0.01 m/s (terminal settling velocity corresponding to dust having a particle diameter of about several μm). The flow rate of the ascending airflow R6 may be 0.4 m/s to 2.0 m/s (terminal settling velocity corresponding to dust having a particle diameter of about 40 μm to 100 μm).

The flow rate of the ascending airflow R6 may be varied by adjusting the cross-sectional area of the tube body 18. For example, an air volume Q (m³/min) can be expressed as a cross-sectional area A (m²) of the tube body 18a*a flow velocity V (m/s) of the tube body 18*60 (s/min). Since the air volume Q depends on the diameter of the air introduction pipe 19, when the air volume Q is under a constant condition, the flow rate of the tube body 18 changes in inverse proportion when the cross-sectional area A in the tube body 18 is changed. Therefore, the above range may be realized by adjusting the cross-sectional area of the tube body 18.

The lengths of the tube body 18 and the air introduction pipe 19 can be appropriately set, and may be, for example, about 20% to 80% of the depth of the storage space S2. When the air introduction pipe 19 is too short (for example, less than 20% of the depth of the storage space S2), the length from the lower end of the air introduction pipe 19 to the bottom of the storage space S2 becomes long. Thus, the air descending from the air introduction pipe 19 diffuses or attenuates before reaching the bottom of the storage space S2, and the winding effect of the fine dust introduced into the bottom of the storage space S2 may be weakened. When the air introduction pipe 19 is too long (80% or more of the depth of the storage space S2), the large particles may quickly fill the lower end of the air introduction pipe 19. When the air introduction pipe 19 is buried in the large particles, the amount of air taken in decreases, and the ascending airflow R6 generated in the tube body 18 is weakened. Therefore, the fine dust is likely to fall, and the fine dust is likely to be introduced into the storage space S2.

When the tube body 18 is too short (e.g., less than 20 mm), the ascending airflow R6 generated in the tube body 18 may be weakened, the fine dust may be more likely to fall, and the fine dust may be more likely to be introduced into the storage space S2. When the tube body 18 is too long (80% or more of the depth of the storage space S2), the large particles may quickly fill the lower end of the tube body 18. In the case where the lower end of the tube body 18 is buried, there is no destination for the fumes that have been introduced into the storage space S2 to be wound up, and thus the winding effect of the fine dust may be lost. In addition, when the lower end of the tube body 18 is about to be buried, the flow velocity increases due to the narrowing of the air inlet, and thus large particles may also be swirled up.

For the above reasons, the lengths of the tube body 18 and the air introduction pipe 19 are set to about 20% to 80% of the depth of the storage space S2.

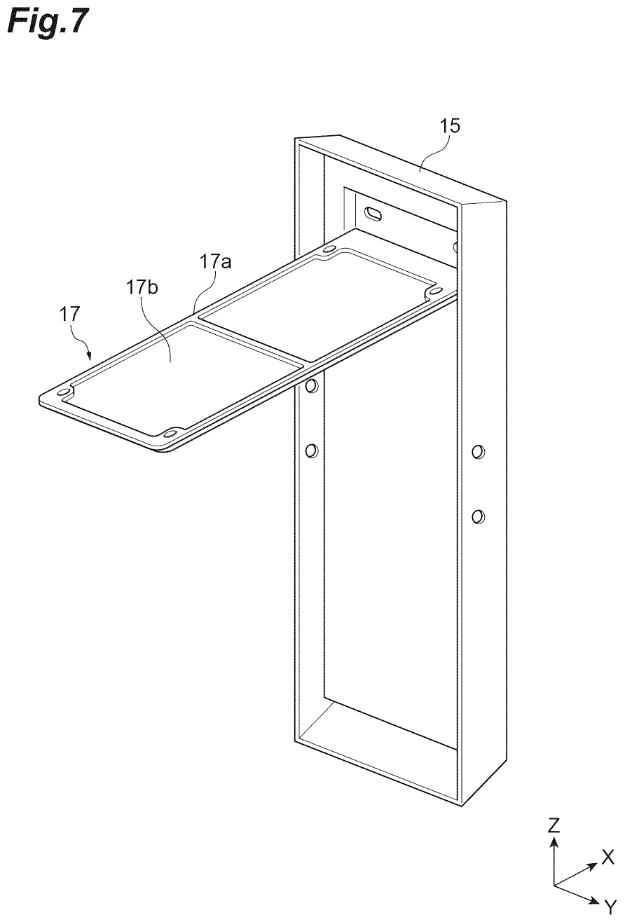

The inspection lid 15 may support the filter 17. FIG. 7 is a perspective view showing an example of the inspection lid and the filter. The filter 17 has a frame body 17a and a wire mesh 17b supported by the frame body 17a. The mesh of the wire mesh 17b is larger than the fine dust and smaller than the large particles. The end of the filter 17 is fixedly supported on the inspection lid 15. This allows the filter 17 to be easily removed from the classification space S1 by removing the inspection lid 15 from the body 10.

### Summary of Embodiment

According to the classification device 1, the fine dust adhering to large particles stored in the storage container 22 can be scattered in the storage space S2 by using air introduced from the air introduction pipe 19. The fine dust scattered in the storage space S2 is carried on the ascending airflow R6 from the lower discharge port 18c of the body 10 to the classification space S1, and further carried on the airflow R2 to the upper discharge port 10b of the body 10. In this way, the classification device 1 can further remove the fine dust from the large particles which are classified from the dust and stored. Therefore, the classification device 1 can appropriately separate the foreign matter from the dust.

Although various exemplary embodiments have been described above, various omissions, substitutions, and changes may be made without being limited to the above-described exemplary embodiments.

The tube body 18 may be formed integrally with the body 10, or may be formed separately from the body 10 and connected to the body 10. The lower end of the air introduction pipe 19 may not face the bottom of the storage container 22. The storage container 22 and the input container 24 may be distributed as consumables. The suction device 23 is not limited to the suction device 23 of the embodiment, and any device having a suction function can be applied.

### Overview of Embodiments of the Present Disclosure

The present disclosure includes the following aspects.

### Clause 1

According to an aspect of the present disclosure, there is provided a classification device including a hose configured to suck dust containing fine dust and foreign matter from a tip thereof, a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space, a lid member configured to be mounted on a container defining a storage space for storing the foreign matter discharged from the lower discharge port of the body, including an air intake configured to communicate with the storage space, and positioned below the body, and an air introduction pipe connected to the air intake of the lid member and configured to be disposed in the storage space.

In this classification device, the suction device is connected to the upper discharge port of the body. The suction device sucks the air in the classification space, so that the classification space has a negative pressure. As a result, an airflow from the tip of the hose toward the classification space of the body is generated. The dust including the fine dust and the foreign matter is sucked from the tip of the hose by the airflow and introduced into the classification space of the body. In the classification space, an airflow toward the upper discharge port of the body is generated. In the classification space, the fine dust contained in the dust is carried to the upper discharge port of the body by the airflow, and the foreign matter contained in the dust falls to the lower portion of the body by gravity. The foreign matter falls from the lower discharge port of the body into the storage space of the container and is stored therein.

Since the storage space communicates with the classification space via the lower discharge port, the storage space has a negative pressure. Thus, air is taken in from the air intake of the lid member. The air is introduced into the storage space through the air introduction pipe. The air introduced from the air introduction pipe hits the foreign matter stored in the container and causes the fine dust adhering to the foreign matter to scatter into the storage space. In the storage space, an airflow toward the lower discharge port of the body is generated. The fine dust scattered in the storage space is carried by the airflow from the lower discharge port of the body to the classification space, and further carried by the airflow to the upper discharge port of the body.

In this way, the classification device can further remove the fine dust from the foreign matter classified from the dust and stored. Therefore, the classification device can appropriately separate foreign matter from dust.

### Clause 2

In the classification device according to clause 1, the air introduction pipe may be connected to the air intake of the lid member so that a lower end thereof faces a bottom of the container. In this case, the air is introduced towards the bottom of the container. Since the introduced air is reversed at the bottom of the container and rises, the air introduction pipe can efficiently scatter fine dust adhering to the foreign matter into the storage space.

### Clause 3

In the classification device according to clause 1 or 2, the lower portion of the body may be formed by a tube body, and the tube body has a cross-sectional area smaller than a cross-sectional area of a center of the body, and a lower end of the tube body forms the lower discharge port. Accordingly, the ascending airflow from the storage space to the classification space is appropriately maintained inside the tube body. Therefore, even when the fine dust is separated from the foreign matter while the foreign matter is falling, and even when the fine dust moves downward due to the inertial force generated when the dust is introduced into the classification space, the fine dust is prevented from falling into the storage space because the ascending airflow transports the fine dust upward.

### Clause 4

The classification device according to any one of clauses 1 to 3 may further include a coarse filter provided at the tip of the hose and having a plurality of openings, wherein each of the plurality of openings is smaller than the opening of the hose. The classification device can avoid sucking a foreign matter larger than the size of each of the plurality of openings.

### Clause 5

The classification device according to any one of clauses 1 to 4 may further include a detachable inspection lid forming a part of a side wall of the body, and a filter disposed upstream of the upper discharge port provided in the upper portion of the body, supported by the inspection lid, and configured to separate the fine dust and the foreign matter. Foreign matter that does not fall but rides on the airflow toward the upper portion of the body is removed by the filter. The filter can be easily taken out of the classification space by removing the inspection lid from the body. Therefore, the load of cleaning the filter is reduced.

### Clause 6

According to another aspect of the present disclosure, there is provided a dust compaction system including a classification device and a compaction device, wherein the classification device includes a hose configured to suck dust containing fine dust and foreign matter from a tip thereof, a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space, a lid member configured to be mounted on a container defining a storage space for storing the foreign matter discharged from the lower discharge port of the body, including an air intake configured to communicate with the storage space, and positioned below the body, and an air introduction pipe connected to the air intake of the lid member and configured to be disposed in the storage space, and, wherein the compaction device is configured to receive the fine dust having passed through the upper discharge port of the body and compresses the fine dust to form a pellet.

In this dust compaction system, the same effect as that of the above-described classification device is achieved. Further, in this dust compaction system, the foreign matter is removed from the dust, and the fine dust is thrown into the compaction device. Therefore, the operation failure of the compaction device is reduced. Further, the formability of the pellet is improved.

What is claimed is:

1. A classification device comprising:
a hose configured to suck dust containing fine dust and foreign matter from a tip thereof;
a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space;
a lid member configured to be mounted on a container defining a storage space for storing the foreign matter discharged from the lower discharge port of the body, including an air intake configured to communicate with the storage space, and positioned below the body; and
an air introduction pipe connected to the air intake of the lid member and configured to be disposed in the storage space.

2. The classification device according to claim 1, wherein the air introduction pipe is connected to the air intake of the lid member so that a lower end thereof faces a bottom of the container.

3. The classification device according to claim 1, wherein the lower portion of the body is formed by a tube body, and the tube body has a cross-sectional area smaller than a cross-sectional area of a center of the body, and a lower end of the tube body forms the lower discharge port.

4. The classification device according to claim 1, further comprising a coarse filter provided at the tip of the hose and having a plurality of openings, wherein each of the plurality of openings is smaller than the opening of the hose.

5. The classification device according to claim 1, further comprising:
a detachable inspection lid forming a part of a side wall of the body; and
a filter disposed upstream of the upper discharge port provided in the upper portion of the body, supported by the inspection lid, and configured to separate the fine dust and the foreign matter.

6. A dust compaction system, comprising a classification device and a compaction device, wherein the classification device comprises:
a hose configured to suck dust containing fine dust and foreign matter from a tip thereof;
a body defining a classification space therein, connected to an end of the hose so that the hose communicates with the classification space, including an upper discharge port and a lower discharge port, the upper discharge port being provided in an upper portion of the body so as to be connected to a suction device that creates a negative pressure in the classification space, and the lower discharge port being provided in a lower portion of the body so as to discharge the foreign matter that has fallen into the classification space;
a lid member configured to be mounted on a container defining a storage space for storing the foreign matter discharged from the lower discharge port of the body, including an air intake configured to communicate with the storage space, and positioned below the body; and
an air introduction pipe connected to the air intake of the lid member and configured to be disposed in the storage space, and wherein the compaction device is configured to receive the fine dust having passed through the upper discharge port of the body and compresses the fine dust to form a pellet.
